(19) United States
(12) Patent Application Publication
(10) Pub. No.: US 2017/0090272 A1
(43) Pub. Date: Mar. 30, 2017

(54) FOLDABLE CAMERA AND PROJECTOR WITH CODE ACTIVATED CONTROLS

(71) Applicant: Muneer Ayaad, Vernon, CT (US)

(72) Inventor: Muneer Ayaad, Vernon, CT (US)

(21) Appl. No.: 15/152,802

(22) Filed: May 12, 2016

Related U.S. Application Data
(60) Provisional application No. 62/160,258, filed on May 12, 2015.

(51) Int. Cl. G03B 17/54; G09B 5/02; B42F 13/40; G06K 9/00

(52) U.S. Cl. CPC G03B 17/54; G06K 9/00442; G09B 5/02; B42F 13/40

(57) ABSTRACT

A camera and projector device includes a housing defining a base and first housing section extending from the base. A second housing section is pivotally attached to the first housing section via a first hinge. The camera and projector device includes a camera hingedly mounted to the first housing section via a second hinge. The camera and projector device includes a projector pivotally mounted to the second housing section via a third hinge. The camera is foldable into the first housing section and the second housing section is foldable over the camera and onto the first housing section.

### CROSS REFERENCE TO RELATED APPLICATIONS

The instant application is a non-provisional application of and claims priority to co-pending U.S. Provisional Patent Application No. 62/160,258 filed on May 12, 2015 and entitled “Foldable Camera and Projector with Code Activated Controls”, the entirety of which is incorporated by reference herein.

### TECHNICAL FIELD

The present invention is directed to a foldable camera and projector device for detecting printed codes on a substrate; and to augmented reality software that analyzes the codes, relates the codes to a data file, and controls the projector to display indicia relating to the data files on a target substrate. The present invention also relates to a notebook assembly having such a foldable camera and projector device mounted therein.

### BACKGROUND

Projectors are commonly used to upload data files from a computer and to display images and videos on a screen. Such projectors can be used in a variety of applications including educational settings and advertising. For example, students may view a projected video and make notes of the video on a notebook or in a computer. However, the students' interactivity with the video is somewhat limited. Moreover, an instructor or the student typically searches files or the internet for suitable content to display. Such projector and computer systems provides are generally complex and poorly linked to structured lesson plans. In addition, such use of projectors does not provide for individual student preferences and needs.

### SUMMARY OF THE INVENTION

In one aspect there is disclosed herein a camera and projector device that includes a housing defining a base and first housing section extending from the base. A second housing section is pivotally attached to the first housing section via a first hinge. The camera and projector device includes a camera hingedly mounted to the first housing section via a second hinge. The camera and projector device includes a projector pivotally mounted to the second housing section via a third hinge. The camera is foldable into the first housing section. The second housing section is foldable over the camera and onto the first housing section.

In another aspect, there is disclosed herein a notebook, camera and projector assembly. The assembly includes a notebook that includes a notes section hingedly attached to a hub section via a hub hinge. The hub section has a groove formed therein. A camera and projector device are pivotally mounted to the hub section and seatable in the groove.

### BRIEF DESCRIPTION OF THE DRAWINGS

FIG. 1 is a perspective view of a foldable camera and projector device of the present invention shown in an unfolded state;

FIG. 2 is a perspective view of the foldable camera and projector device of FIG. 1, shown in a folded state;

FIG. 3 is a perspective view of the camera and projector device of FIG. 1 shown in proximity to a code printed on a target substrate;

FIG. 4 is a sketch of students in a classroom setting using the camera and projector device of FIG. 1;

FIG. 5 is a perspective view of the camera and projector device of FIG. 1 with a swivel feature for rotation of the projector relative to the device;

FIG. 6. Is a sketch a classroom setting illustrating two students using the camera and projector device of FIG. 5 with the projector rotated;

FIG. 7 is an example of a target substrate;

FIG. 8 is a summary table of an exemplary set of specifications for the camera and projector device of the present invention;

FIG. 9 is a schematic drawing of the camera and projector device of the present invention shown in an unfolded state and in a standby mode;

FIG. 10 is a schematic drawing of the camera and projector device of the present invention shown in an unfolded state and in an initial scanning mode with a target substrate in camera detection range;

FIG. 11 is a schematic drawing of the camera and projector device of FIG. 10 shown in a projection mode;

FIG. 12 is a schematic drawing of the camera and projector device of the present invention shown in an unfolded state and a target substrate pulled out of the camera detection range;

FIG. 13 is a schematic drawing of the camera and projector device of the present invention shown in an unfolded state and in an initial scanning mode with another target substrate in camera detection range;

FIG. 14 is a schematic drawing of the camera and projector device of FIG. 10 shown in another projection mode;

FIG. 15 is a schematic drawing of the camera and projector device of the present invention shown in an unfolded state and a target substrate pulled out of the camera detection range;

FIG. 16 is a perspective view of a notebook having a foldable camera and projector device of the present invention shown in folded state;

FIG. 17 is a perspective view of a notebook having a foldable camera and projector device of FIG. 16 with the camera and projector device pivoted out and up from the base;

FIG. 18 is a perspective view of the notebook having a foldable camera and projector device of FIG. 17 further showing the projector in an extended state;

FIG. 19 is a perspective view of the notebook having a foldable camera and projector device of FIG. 18 further showing the printed code and projection area in an operational position;

FIG. 20 is a perspective view of another embodiment of the foldable camera and projector device of FIG. 2 having a camera and projector mounted on an exterior surface of the second section; and

FIG. 21 is a perspective view of another embodiment of a notebook having a foldable camera and projector device.

### DETAILED DESCRIPTION

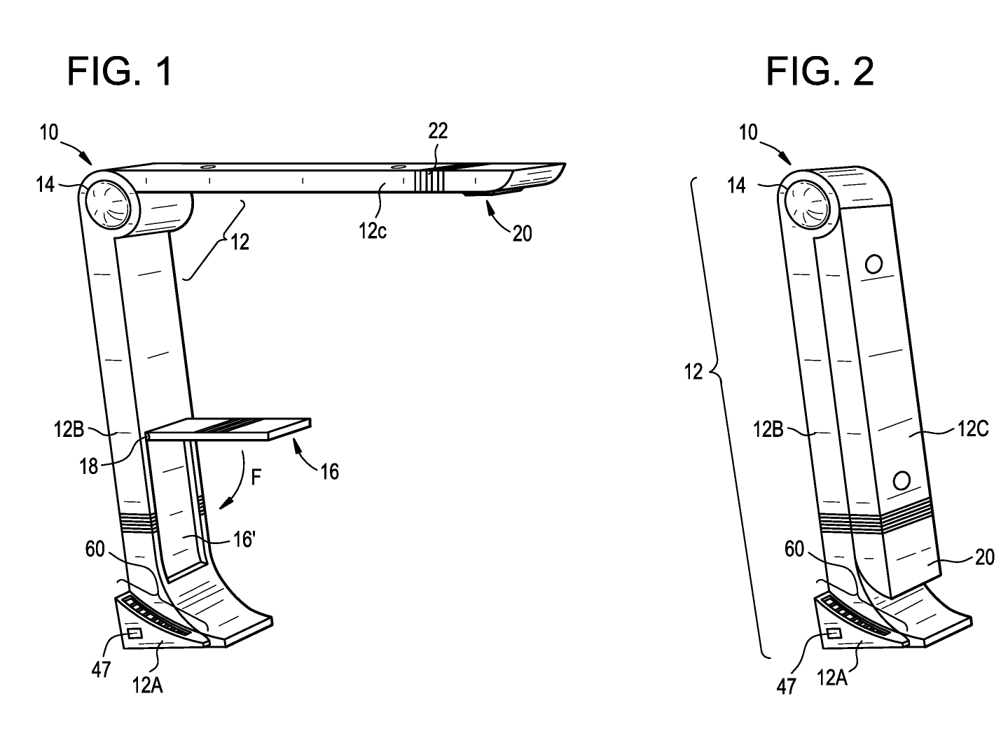

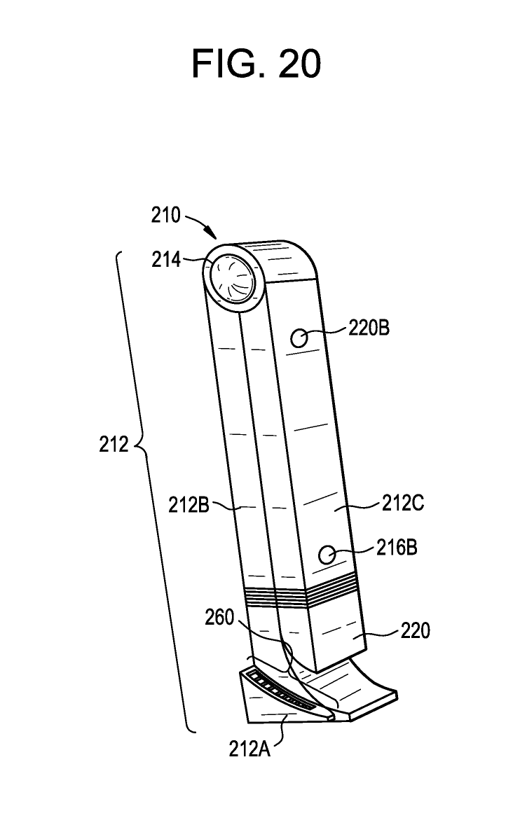

As shown in FIGS. 1-3, a camera and projector device is generally designated by the numeral 10. The camera and projector device 10 includes a housing 12 defining a base 12A and first housing section 12B extending from the base 12A. A second housing section 12C is pivotally attached to the first housing section 12B via a first hinge 14. The camera and projector device 10 includes a camera 16 hingedly mounted to the first housing section 12B via a second hinge 18 for angular movement through 350 degrees relative to the first housing section 12B. The camera and projector device 10 includes a projector 20 pivotally mounted to the second housing section 12C via a third hinge 22 (e.g., a multi-directional, multi-axis hinge allowing rotation about a longitudinal axis of the second housing section 12C and 350 degree angular movement relative to the second housing section 12C). While the camera 16 is shown hingedly attached to the first housing section 12B by the second hinge 18 and the projector 20 is shown pivotally attached to the second housing section 12C by the third hinge 22, the present invention is not limited in this regard as alternative and/or additional cameras and/or projectors may be employed at different locations. For example, FIG. 20 illustrates a projector 220B positioned on an exterior surface of the second housing section 212C and a camera 216B positioned on the exterior surface of the second housing section 212C.

The camera 16 is foldable into the first housing section 12B and the second housing section 12C is foldable over the camera 16 and onto the first housing section 12B. For example, as shown in FIG. 1, the camera 16 is shown in an extended position active and ready for use. The camera 16′ is shown in dashed lines in a folded position abutting a portion of the first housing section 12B of the housing 12. As shown in FIG. 2, the second housing section 12C and the projector 20 are folded over the camera 16′ and against the first housing section 12B.

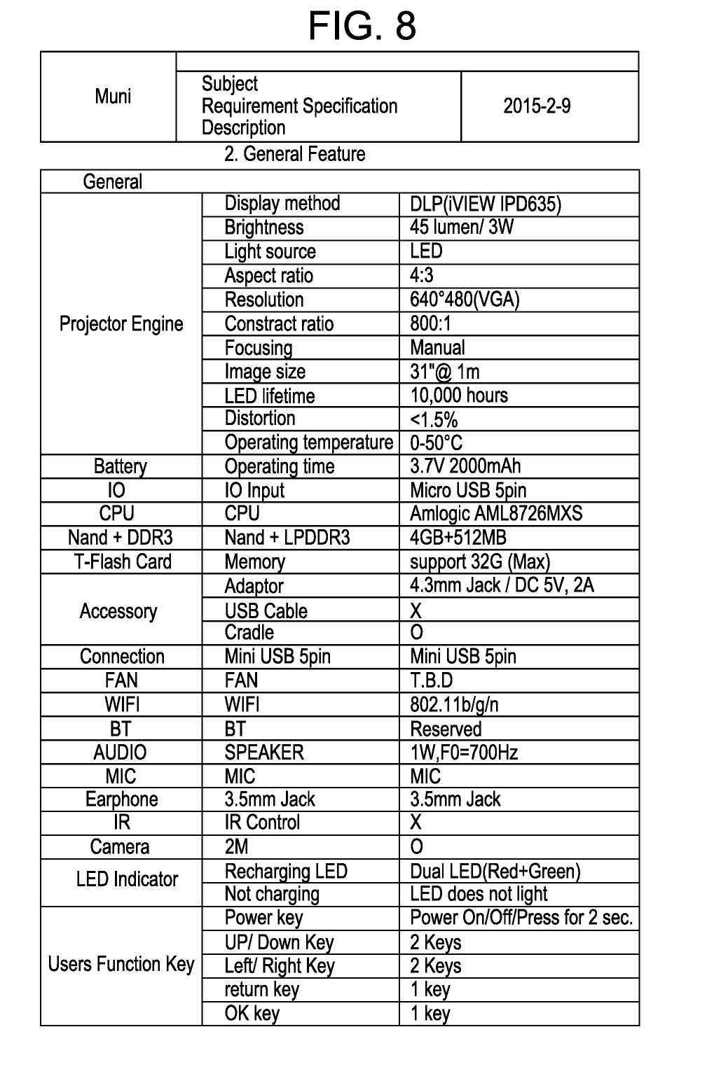

As shown in FIG. 1, the camera and projector device 10 includes a control pad 60, that includes a power on/off button, up/down buttons, left/right buttons, a return key and an confirm key, as well as lighting indicators (e.g., LEDs) for indication of power on/off and charging status. In one embodiment, the camera and projector includes a speaker, a microphone, a head phone connection, a memory card, a battery, a battery charger, a USB port and/or other components and features identified in FIG. 8.

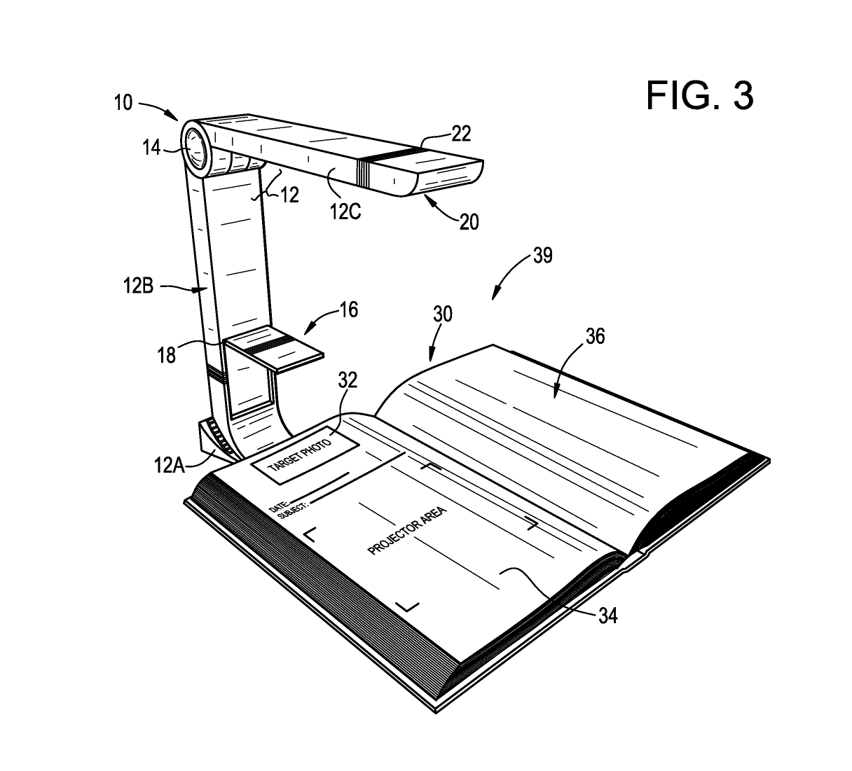

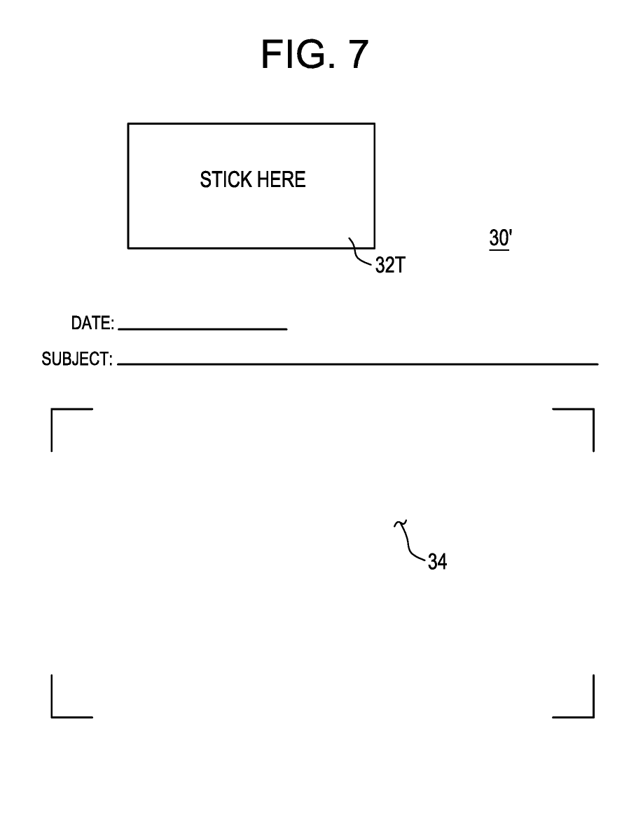

As shown in FIG. 3, the camera and projector device 10 includes a target substrate 30. The target substrate 30 has a printed code 32, a projection area 34 and an area 36 for receiving information thereon. In one embodiment, the target substrate 30 is a printed page 30′ as shown in FIG. 7 that includes a target area 32T for placement of the printed code 32 thereon. In one embodiment, the printed page 30′ is one of a plurality of printed pages assembled (e.g., bound) in a notebook 39. The printed code 32 being positionable within viewing range of the camera 16.

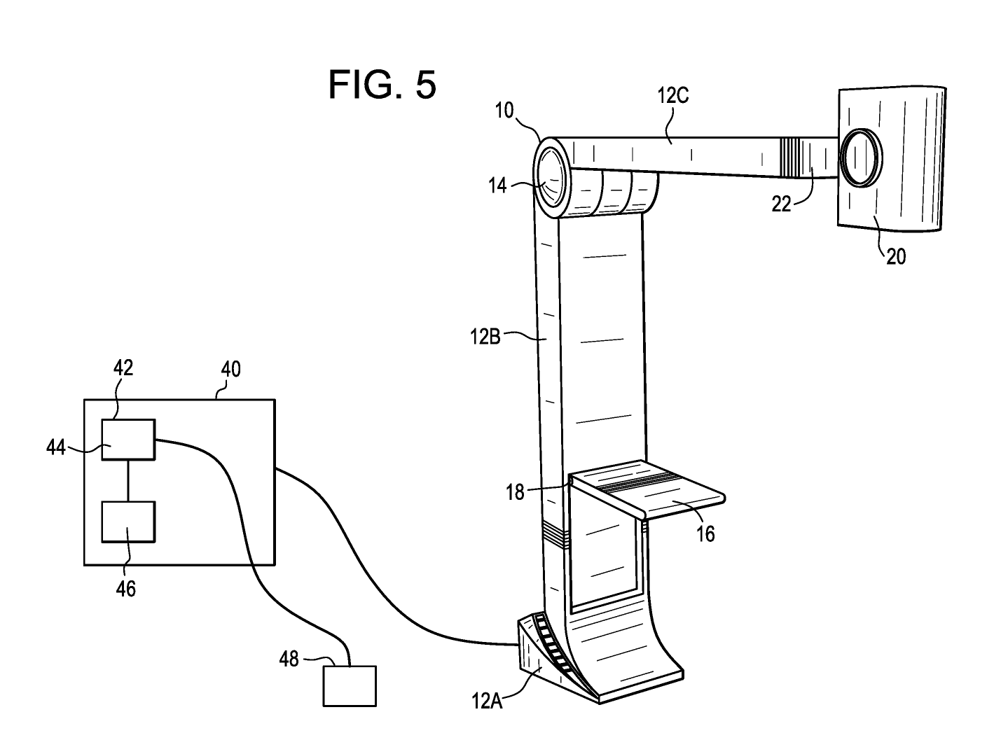

As shown in FIG. 5, the camera and projector device 10 include a computer 40 having a central processing and control unit 42 that has augmented reality software 44 programed therein. For example, the augmented reality software integrates digital information with live video or a user's environment in real time. The computer 40 includes a database 46 in communication with the central processing and control unit 42. The central processing and control unit 42 is in communication with the internet 48 or a cloud data storage system. The augmented reality software 44 is configured to: (1) detect the presence of the printed code 32 when placed within the viewing range of the camera 16; (2) generate and transmit first signals to the projector 20 to display the printed code 32 on the projection area 34; (3) correlate the printed code 32 to data files in the data base 46; and (4) generate and transmit second signals to the projector 20 to display indicia relating to at least one file in the data base.

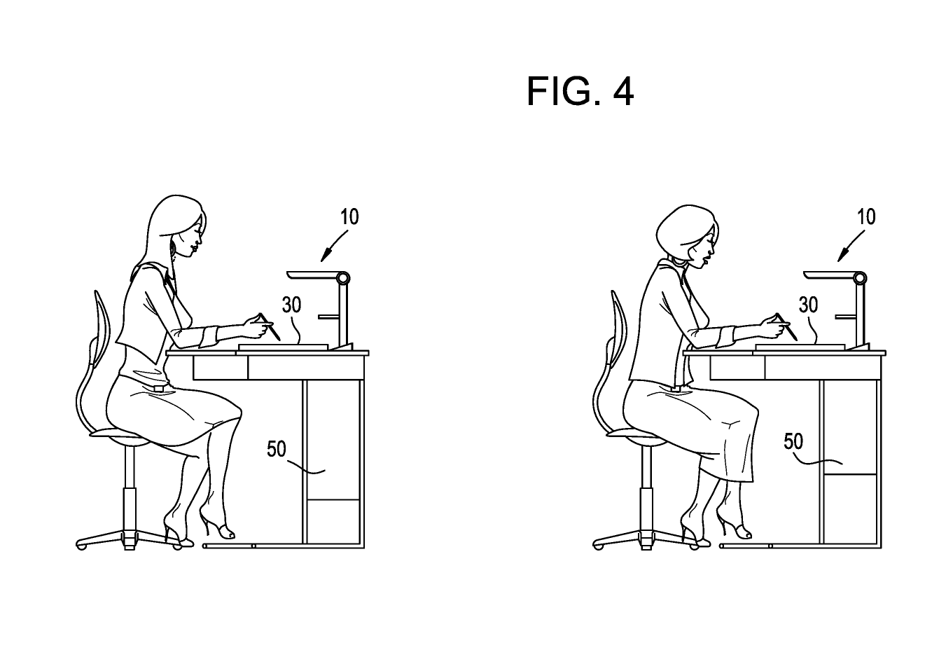

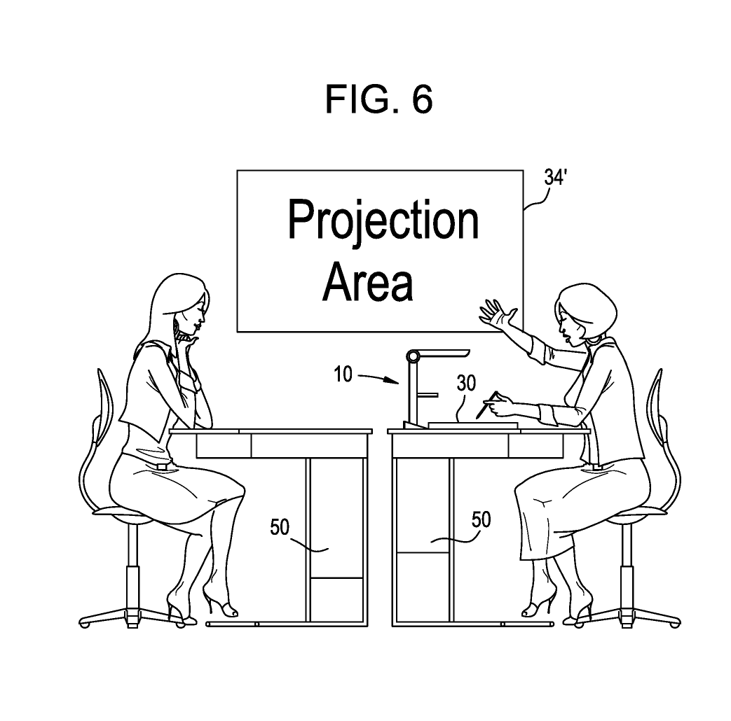

The camera and projection device 10 has utility in various applications including but not limited to educational settings, video conferencing and Skype® (a registered trademark of Skype Technologies, S.A.) communications. The camera and projection device is portable and is hand held by a user (e.g., 10 to 18 inches long, 2 to 5 inches wide, and 0.5 to 1.5 inches thick). The camera and projection device 10 includes a battery 47 that is chargeable as necessary. For example, FIG. 4 illustrates two work stations 50 each of which employ one of the camera and projector devices 10 along with a target substrate 30; and FIG. 6 illustrates two workstations 50 wherein one workstation employs the camera and projector device 10 with the projector 20 swiveled with respect to the second housing section 12B of the housing 12 so that the an image is displayed on a projection area 34′ located on a wall. In use in such educational settings, the printed code 32 is provided to the students by an instructor. The students place the printed code 32 on the target areas 32T (see FIG. 7). The students then position the printed code 32 within the range of the camera 16 to initiate the lesson plan that is downloaded by the software 44 from the data base 46. The lesson plans include, for example, videos for use in educational introduction, revision or to develop a better understanding of a certain topic. Teachers ask the students to watch the videos and write notes on the area 36 for receiving information (see FIG. 3) prior to class for an effective class discussion. Students who have a difficult time understanding or remembering a topic could watch the video related to the notes. This will enhance a faster understanding and refresh memory.

As shown in FIG. 8, in one embodiment, the camera and projector device 10 includes specific component specification for the projector 20, camera 16, the control pad 60 and other functions of the camera and projector device 10.

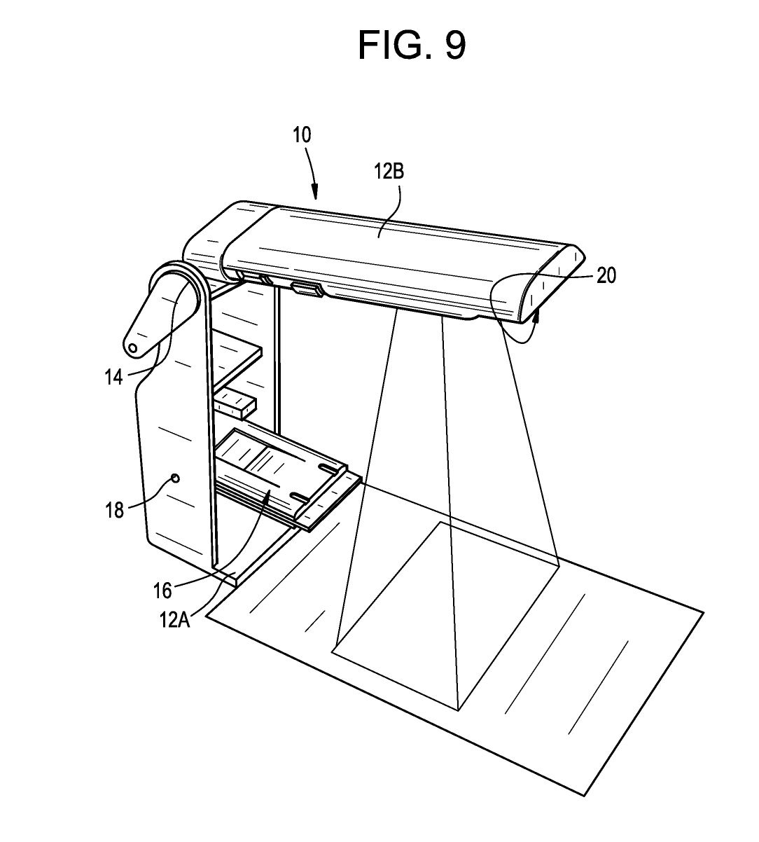

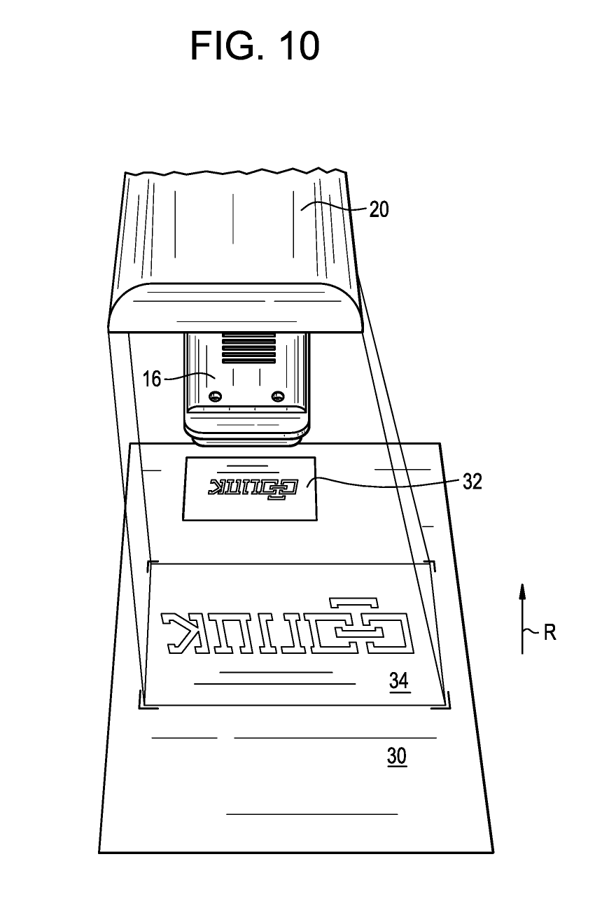

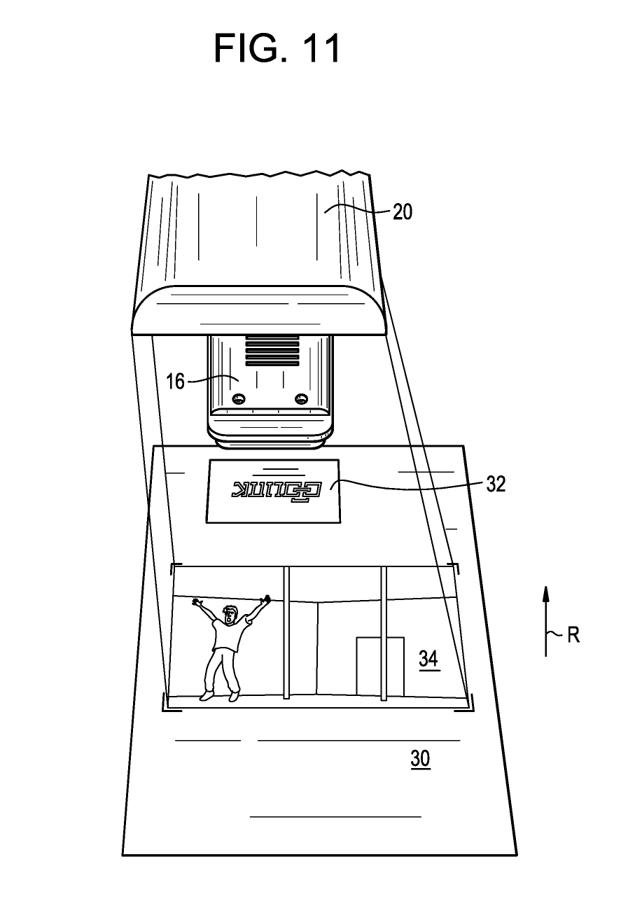

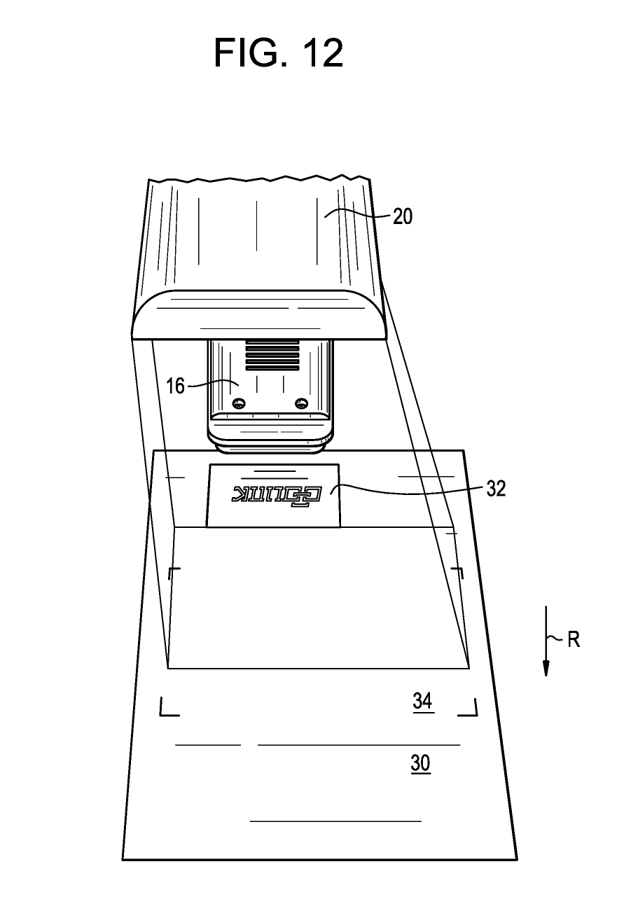

Operation of the camera and projector device 10 can be best understood with reference to FIGS. 9-15. As shown in FIG. 9, the camera and projector device 10 is powered up and in a standby state projecting a beam of light on a substrate. As shown in FIG. 10 a user places a target substrate 30 with the printed code 32 in the viewing range of the camera 16 in the general direction of the arrow R. The central processing and control unit 42 processes the printed code 32 and causes the projector to display the printed code 32 on the projection area 34. The central processing and control unit 42 correlates the printed code 32 to a specific file in the data base 46 and uploads the file and indicia of the file (e.g., a video, PowerPoint presentation slides, photos or the like) and causes the projector 20 to display the indicia on the projection area as shown in FIG. 11. As shown in FIG. 12, the target substrate 30 is moved out of the viewing range of the camera 16 in the direction of the arrow R′, the camera 16 senses this and central processing and control unit 42 causes the projector 20 to display a beam of light. At any point in the process the user can print a snapshot of the indicia appearing on the projection area 34. At any point in the process the user may select Wi-Fi settings and location of the projection area (e.g., on the target substrate 30 or on a wall or screen).

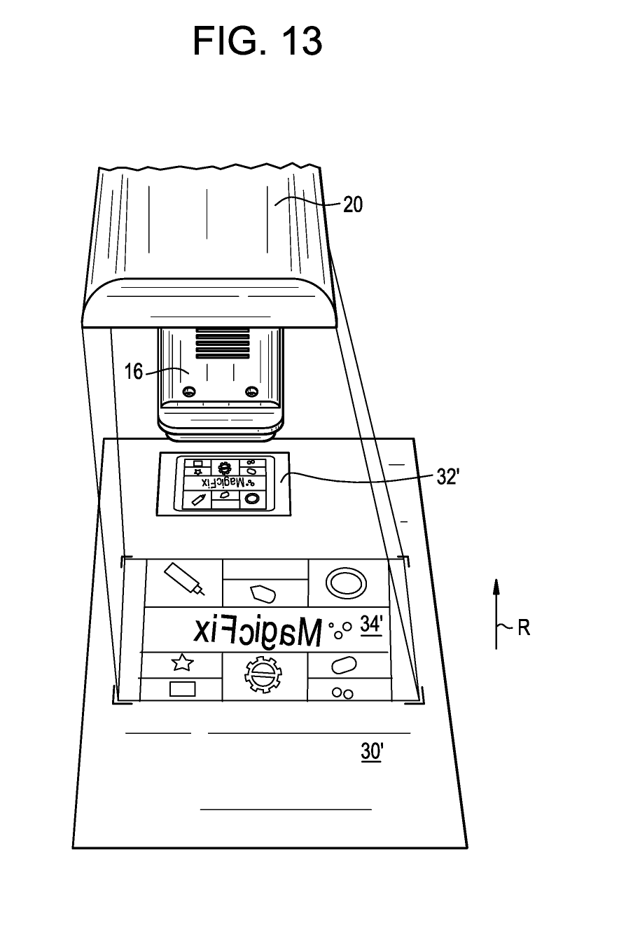

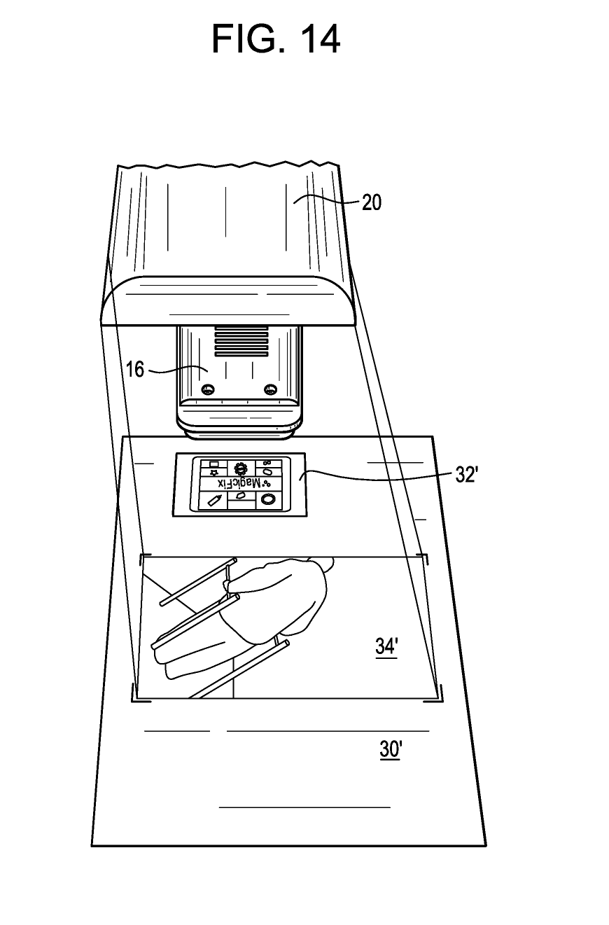

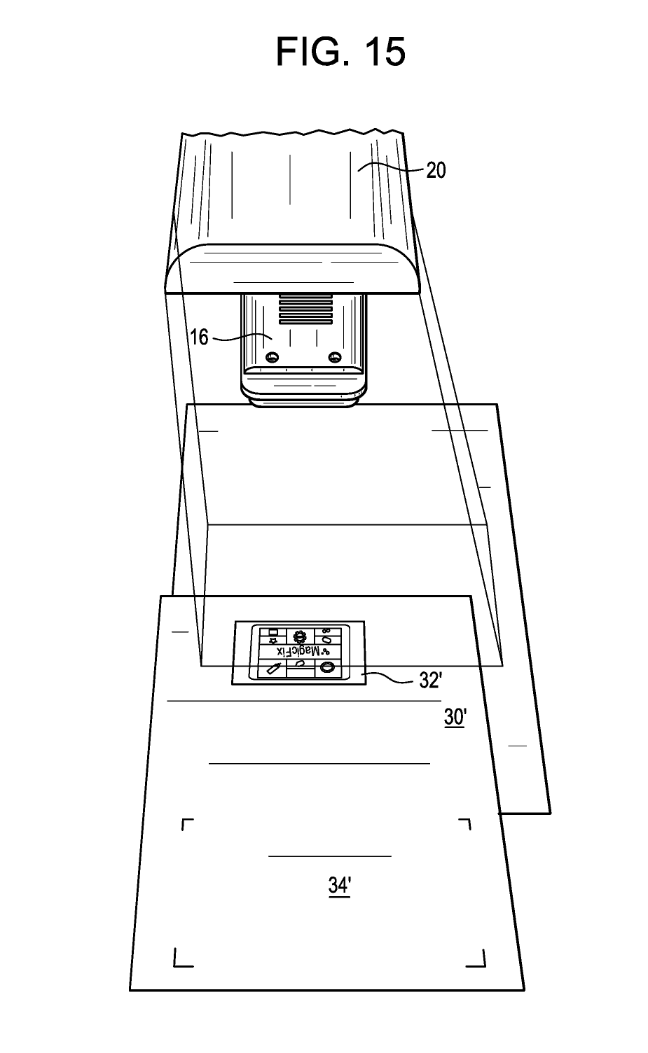

As shown in FIG. 13 a user places another target substrate 30′ with another printed code 32′ in the viewing range of the camera 16 in the general direction of the arrow R. The central processing and control unit 42 processes the printed code 32′ and causes the projector to display the printed code 32′ on the projection area 34′. The central processing and control unit 42 correlates the printed code 32′ to another specific file in the data base 46 and uploads the file and indicia of the file (e.g., a video, PowerPoint presentation slides, photos or the like) and causes the projector 20 to display the indicia on the projection area as shown in FIG. 14. As shown in FIG. 15, the target substrate 30′ is moved out of the viewing ranged of the camera 16 in the direction of the arrow R′, the camera 16 senses this and central processing and control unit 42 causes the projector 20 to display a beam of light. At any point in the process the user can print a snapshot of the indicia appearing on the projection area 34′. At any point in the process the user may select Wi-Fi settings and location of the projection area (e.g., on the target substrate 30 or on a wall or screen).

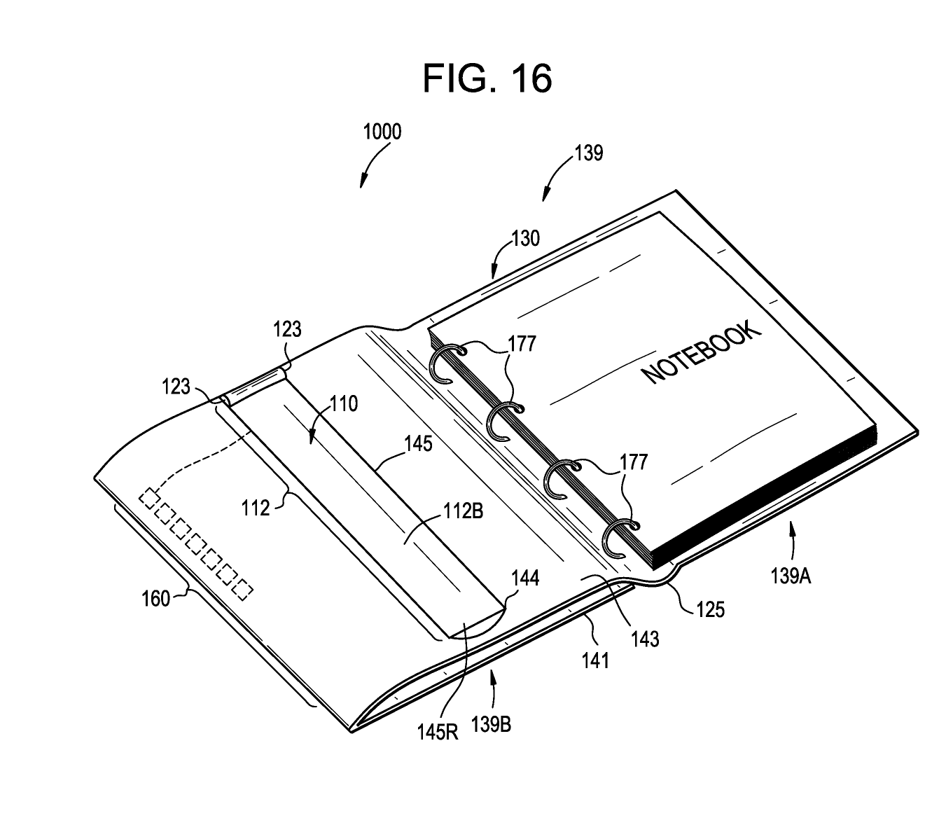

As shown in FIGS. 16-19 a notebook 139 having a foldable camera and projector device 110 similar to the foldable camera and projector device 10 of FIGS. 1-3. Thus, similar components are designated with the reference numbers of FIGS. 1-3 preceded by the number 1. The notebook 139 and foldable camera and projector device 110 of FIGS. 16-19 are collectively referred to herein as notebook, camera and projector assembly 1000. In one embodiment, the notebook, camera and projector assembly 1000 is portable. For example, in one embodiment, the notebook, camera and projector assembly 1000 weighs less than 2 pounds and is less than 16 inches long, less than 12 inches wide and less than 3 inches thick. However, the present invention is not limited in this regard as any size notebook, camera and projector assembly 1000 may be employed.

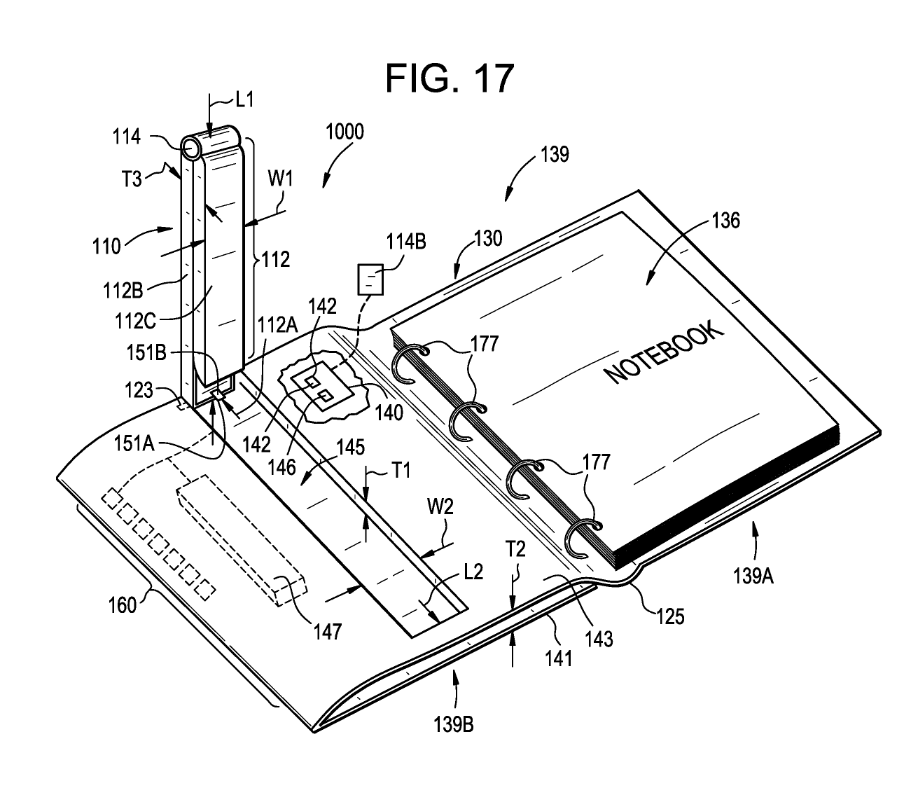

As shown in FIG. 17 the notebook 139 includes a notes section 139A hingedly attached to a hub section 139B via a hinge 125. The notes section 139A stores a plurality of target substrates 130 that are selectively moveable onto the hub section 139B. In one embodiment, the notes section 139A includes a plurality of fasteners 177 secured thereto for removably securing the target substrates 130 to the notes section 139A. The target substrates 130 each include an area 136 for receiving information thereon. The hub section 139B has a thickness T2 that extends between a first surface 141 and a second surface 143. The hub section 139B includes an elongate groove 145 extending from the second surface 143 and terminating at a depth T1 which is less than the thickness T2 of the hub section 139B. The groove 145 has a length L2 and a width W2. The groove 145 is sized and configured to accommodate the foldable camera and projector device 110. Thus, the depth T1 is slightly greater than a thickness T3 of the foldable camera and projector device 110; the length L2 is slightly greater than a length L1 of the foldable camera and projector device 110; and the width W2 is slightly greater than a width W1 of the foldable camera and projector device 110.

As shown in FIGS. 16-19, the hub section 139B includes a control pad 160, that includes a power on/off button, up/down buttons, left/right buttons, a return key and an confirm key, as well as lighting indicators (e.g., LEDs) for indication of power on/off and charging status. In one embodiment, the hub section 139B and/or the camera and projector device 110 includes a speaker, a microphone, a head phone connection, a memory card, a battery, a battery charger, a USB port and/or other components and features identified in FIG. 8.

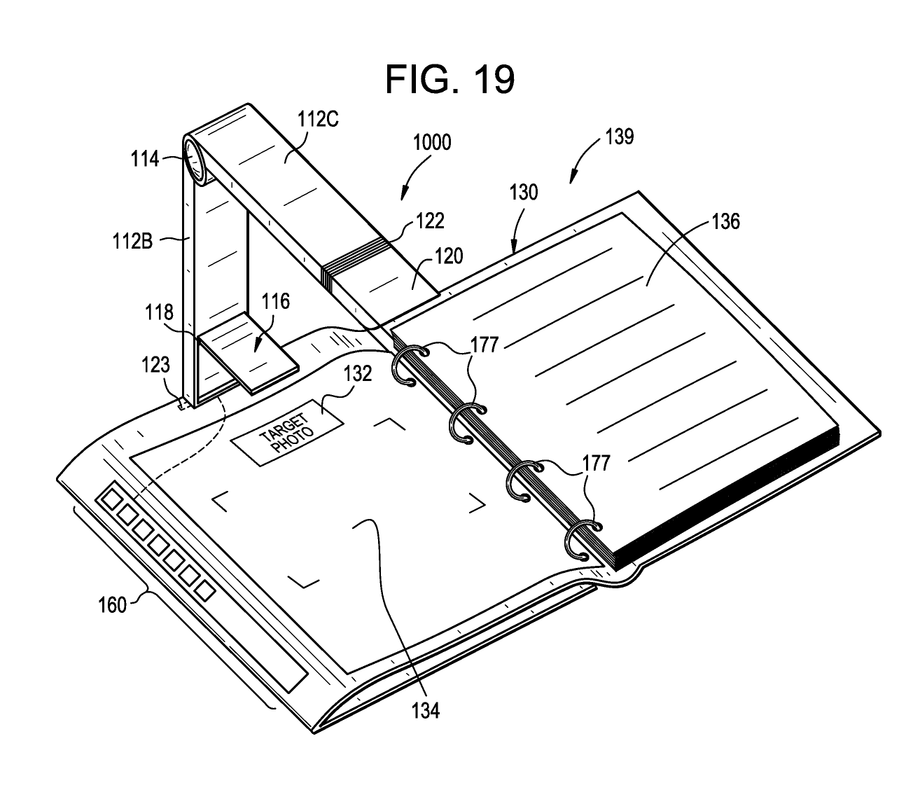

As shown in FIG. 17, in one embodiment, the hub section 139B include a battery 147 (shown in dashed lines), a computer 140 having a central processing and control unit 142 that has augmented reality software 144 programmed therein (shown in a cut away portion of the hub section 139B for clarity of illustration). For example, the augmented reality software 144 integrates digital information with live video or a user's environment in real time. The computer 140 includes a data base 146 in communication with the central processing and control unit 142. The central processing and control unit 142 is in communication with the internet 148 or a cloud data storage system. The augmented reality software 144 is configured to: (1) detect the presence of the printed code 132 (see FIG. 19) when placed within the viewing range of the camera 116; (2) generate and transmit first signals to the projector 120 to display the printed code 132 on the projection area 134 (see FIG. 19); (3) correlate the printed code 132 to data files in the database 146; and (4) generate and transmit second signals to the projector 120 to display indicia relating to at least one file in the database 146.

As shown in FIGS. 17 to 19 the foldable camera and projector device 110 is hingedly secured to the hub section 139B via a hinge 123. In FIG. 16, the foldable camera and projector device 110 is shown folded into the groove 145. In one embodiment, an outer surface of the first housing section 112B is coplanar with the second surface 143 of the hub section 139B. The groove 145 includes a recess 145R at an end thereof thereby forming an access area for pivoting the foldable camera and projector device 110 out of the groove 145 into an extended position as shown in FIG. 17.

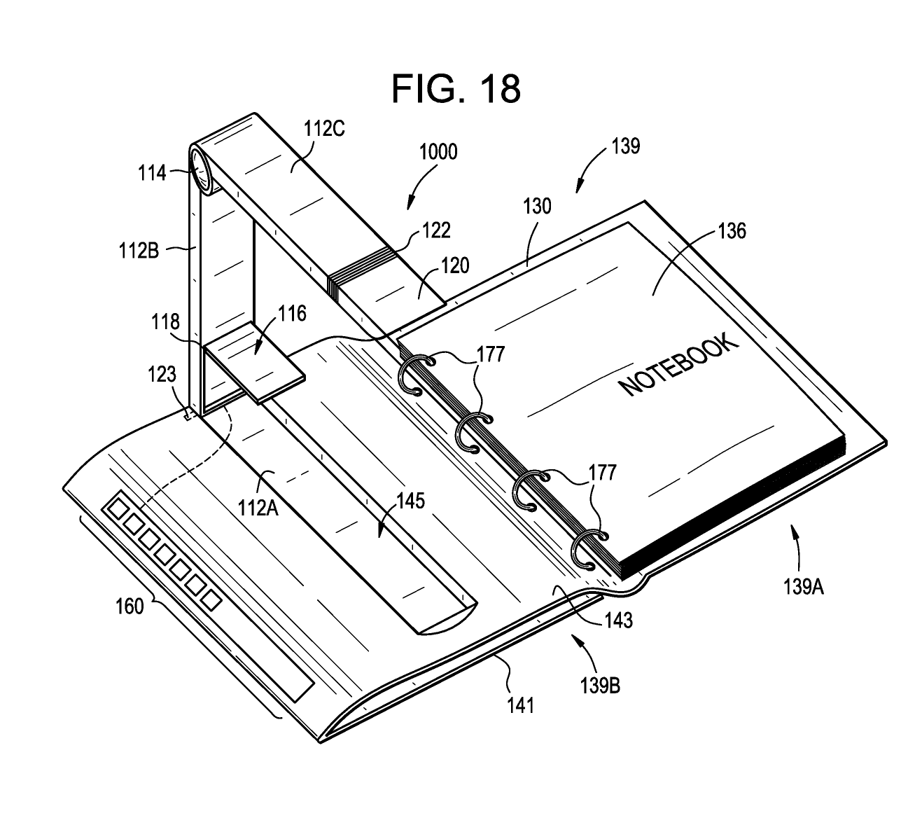

As shown in FIG. 18, the foldable camera and projector device 110 is in the extended position with second housing section 112C is pivoted about the hinge 114 outwardly (e.g., at a 90 degree angle) from the first housing section 112B. The projector 120 rotates 360 degrees about a longitudinal axis of the second housing section 112C. The camera 116 is pivoted about the hinge 118, and is configured to swing an angle of 350 degrees outwardly from the first housing section 112B.

As shown in FIG. 17, the foldable camera and projector device 110 is removably secured to the hub section 139B via a first connector 151A positioned on the foldable camera and projector device 110 and a second connector 151B positioned on the hub section 139B. The first connector 151A and the second connector 151B mechanically and electrically removably couple the foldable camera and projector device 110 to the hub section 139B.

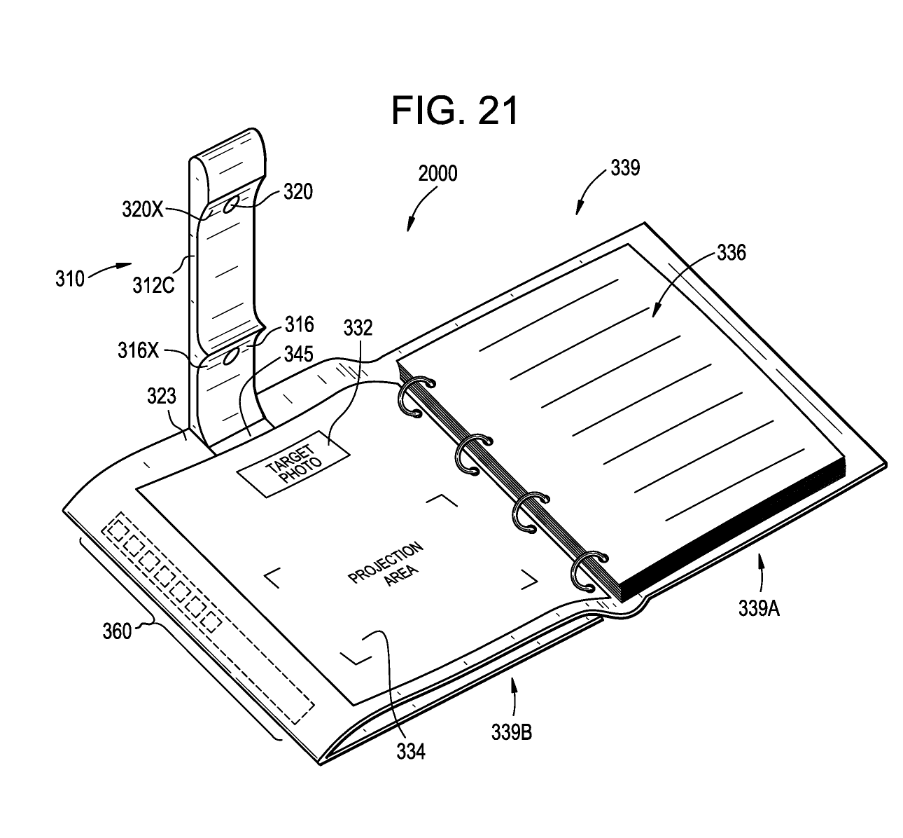

In one embodiment shown in FIG. 21, a notebook, camera and projector assembly 2000 is similar in some respects to the notebook, camera and projector assembly 1000 shown in FIGS. 17-19. Thus similar components are marked with similar element numbers with the first digit “1” replaced with the number “3”. The notebook, camera and projector assembly 2000 differs from the notebook, camera and projector assembly 1000 shown in FIGS. 17-19 in that the foldable camera and projector device 310 of FIG. 21 has no second section similar to the second housing section 112C of FIGS. 17-19. In addition, the foldable camera and projector device 310 of FIG. 21 has a projector 320 mounted on a concave portion 320X of the first housing section 312B; and has a camera 316 mounted on a concave portion 316X of the first housing section 312B. The camera 316 is configured to be focusable on the printed code 332 and the projector is configured to project onto the projection area 334.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A camera and projector device comprising:
a housing defining a base and a first housing section extending from the base and a second housing section pivotally attached to the first housing section via a first hinge;
a camera hingedly mounted to the first housing section via a second hinge; and
a projector pivotally mounted to the second housing section via a third hinge, wherein
the camera is foldable into the first housing section and the second housing section is foldable over the camera and onto the first housing section.

2. The camera and projector device of claim 1, further comprising a target substrate having a printed code, a projection area and an area for receiving information thereon; and
the printed code being positionable within viewing range of the camera.

3. The camera and projector device of claim 1, further comprising:
a computer having a central processing and control unit that has augmented reality software programmed therein, the computer having a database in communication with the central processing and control unit; and
wherein the augmented reality software is configured to:
detect a presence of the printed code when placed within the viewing range of the camera;
generate and transmit first signals to the projector to display the printed code on the projection area;
correlate the printed code to data files in the database; and
generate and transmit second signals to the projector to display indicia relating to at least one file in the database.

4. The camera and projector device of claim 3, wherein the central processing and control unit is in communication with the internet.

5. A notebook, camera and projector assembly, the assembly comprising:
a notebook comprising a notes section hingedly attached to a hub section via a hub hinge, the hub section comprising a groove formed therein; and
a camera and projector device being pivotally mounted to the hub section and seatable in the groove.

6. The assembly of claim 5, wherein the camera and projector device define a base and a first housing section extending from the base and a second housing section pivotally attached to the first housing section via a first hinge;
a camera hingedly mounted to the first housing section via a second hinge; and
a projector pivotally mounted to the second housing section via a third hinge, wherein
the camera is foldable into the first housing section and the second housing section is foldable over the camera and onto the first housing section.

7. The assembly of claim 6, further comprising a target substrate having a printed code, a projection area and an area for receiving information thereon; and
the printed code being positionable within viewing range of the camera.

8. The assembly of claim 7, further comprising:
a computer having a central processing and control unit that has augmented reality software programmed therein, the computer having a database in communication with the central processing and control unit, and
wherein the augmented reality software is configured to:
detect a presence of the printed code when placed within the viewing range of the camera;
generate and transmit first signals to the projector to display the printed code on the projection area;
correlate the printed code to data files in the database;
generate and transmit second signals to the projector to display indicia relating to at least one file in the database.

9. The assembly of claim 8, wherein the central processing and control unit is in communication with the internet.

10. The assembly of claim 5, wherein the camera and projector device define a base and a first housing section extending from the base;
a camera mounted to the first housing section; and
a projector mounted to the first housing section.
